(19) United States
(12) Patent Application Publication
(10) Pub. No.: US 2011/0119770 A1
(43) Pub. Date: May 19, 2011

(54) Password protected CD-DVD

(75) Inventor: Clemy Lee, Cincinnati, OH (US)

(73) Assignee: Clemy Lee, Cincinnati, OH (US)

(21) Appl. No.: 12/587,556

(22) Filed: Nov. 16, 2009

(51) Int. Cl. G06F 7/04; G06F 3/048

(52) U.S. Cl. 726/28; 715/780

(57) ABSTRACT

Writable compact and digital versatile discs with a password protected option that protects access to the information on the disc. The password protection is optional, and may be used or removed at anytime. The discs can be used in every known application designed for compact and digital versatile discs formats, with no limitations.

### CROSS REFERENCE TO RELATED APPLICATION

This application is a continuation-in-part of Ser. No. 12/587,556 filed Oct. 9, 2009 entitled “Password Protected CD-DVD”

### BACKGROUND OF THE INVENTION

This invention relates generally to writable compact and digital versatile discs, and deals more particularly with a unique process for such discs to be access protected. The unique process is designed to allow for a password to be assigned to a writable compact and digital versatile disc before or after the discs natural intended purpose.

Writable compact and digital versatile discs generally can be used by anyone and does not require a password, nor do they have password options available, such discs are used in conjunction with computers to copy, store and install data, and are also used in homes, cars and mobile entertainment systems.

### SUMMARY OF INVENTION

The present inventions of writable compact and digital versatile discs are used without a password protected option. The present invention of writable compact and digital versatile discs does not provide access protection of the data and software that is stored on the disc, such as the unique process described in this disclosure.

This unique process has a password protected option that resides within the writable compact and digital versatile disc that provides an option to assign in any combination a four to seven character alphanumeric password to the disc. The disc is inserted into a computers disc drive that supports compact and digital versatile disc formats, data is then read from the disc which prompts the opening of a sub-window on the desktop window of the computers monitor, the sub-window allows for a password to be assigned to the disc. The sub-window also embodies the options to skip the password process, change or remove a password, or remove the password protected feature from the disk permanently.

### BRIEF DESCRIPTION OF THE DRAWINGS

FIG. 1 shows an exploded view of the password protected option sub-window 1a and its various components, of which are comprised within a writable compact and digital versatile disc.

FIG. 2 illustrates the password protected option sub-window 1a as it actually appears in size in relation to the desktop window of a computers monitor when activated.

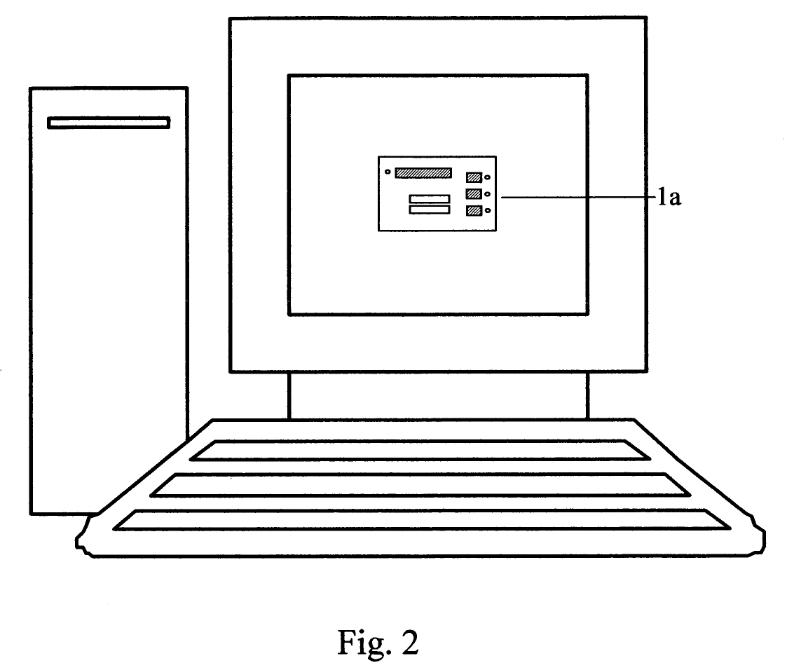

FIG. 3 demonstrates an exploded view example of the password protected option sub-window 1a being used to assign a password to a writable compact and digital versatile disc using components 1b and 1c.

FIG. 4 demonstrates an exploded view example of the password protected option sub-window 1a with the selector button component 3 selected, to activate the corresponding function button component 3a for use.

### DETAILED DESCRIPTION OF THE FIRST EMBODIMENT

In the above-mentioned patent application a password protected option is comprised within writable compact and digital versatile discs, and is disclosed having the ability to assign a password to the discs. The password protected option provides a means of access protection to the information on the disc, allowing only the user access to the disc. The password protected option sub-window is accessed automatically upon insertion of the disc into a computers disc drive that supports compact and digital versatile disc formats. The password protected option sub-window will disengage automatically upon completion of a desired action, or upon removal of the disc from the computers disc drive.

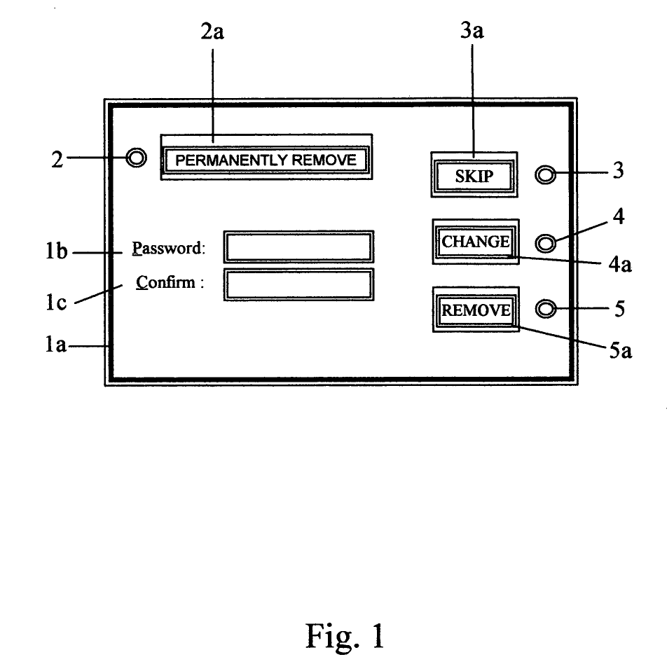

Referring now more particularly to FIG. 1 of the drawings, the password protected option sub-window has an overall general rectangular shape with all of its available components contained within its window. Each option is clearly marked and displayed within the sub-window and is accompanied by a selector button which activates its function.

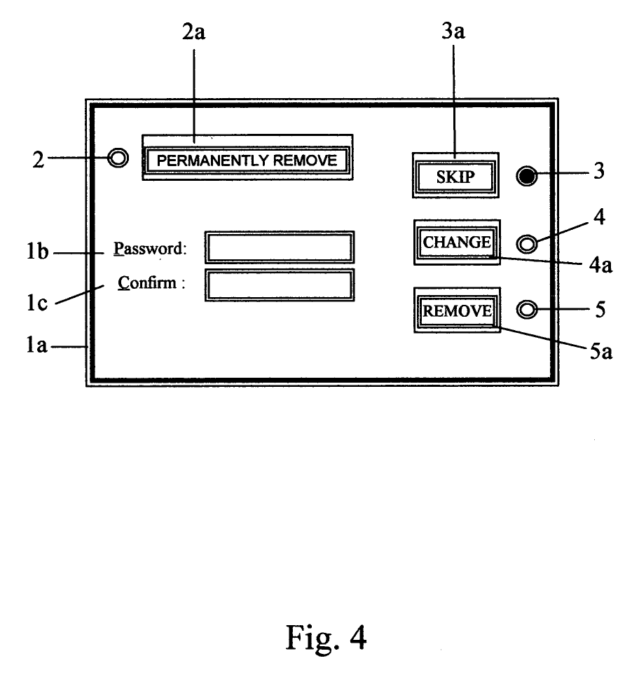

With reference to FIG. 4, the selector buttons 2, 3, 4, and 5 are chosen by pointing the mouse pointer on the selector button and left clicking the mouse pointer just once, the selector buttons when chosen activates it's corresponding function buttons 2a, 3a, 4a, and 5a respectively, the corresponding functions are then chosen by placing the mouse pointer on the clearly marked function button 2a, 3a, 4a, or 5a respectively, and left clicking the mouse pointer just once to complete the action. The selector buttons cannot be used simultaneously. see example 3 and 3a.

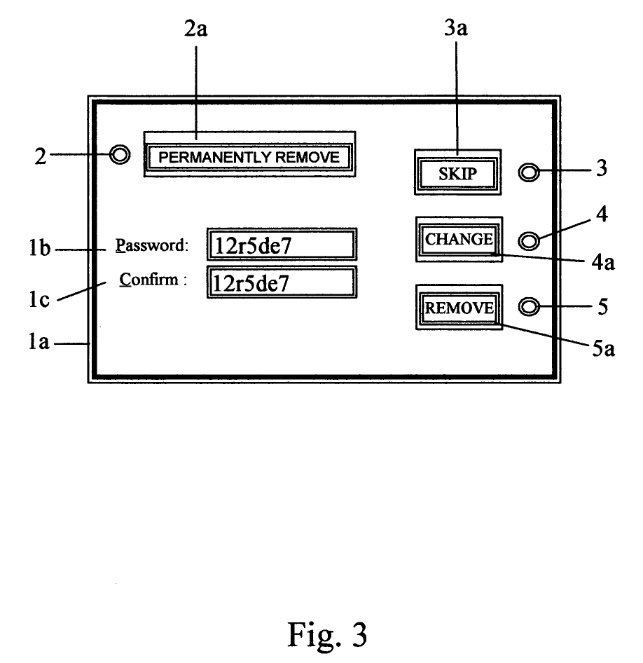

With reference now to FIG. 3, the password is assigned by placing the mouse pointer into the password entry window 1b and left clicking the mouse pointer just once, this will activate the password entry window and the curser will began to flash allowing any combination of a four to seven character alphanumeric password to be assigned. The password must then be confirmed in the confirm entry window 1c by left clicking the mouse pointer just once in the confirm entry window or by pressing the enter/return key on the computers keypad, this will activate the confirm entry window and the curser will began to flash allowing the password to be entered, see example 1b and 1c, after the confirm entry has been made, pressing the enter/return key of the computers keypad will complete this action. The confirm entry window only applies upon newly assigned passwords, and passwords being changed or removed. The option to skip the password process only applies whenever no password is assigned. The option to change or remove a password applies only if a password is assigned. The option to remove the password protected feature from the disc permanently, applies only if no password is assigned. The option to remove the password protected feature from the disc permanently allows for the disc to be used in other applications, such as music and video productions, which are designed for home, car, and mobile entertainment systems. The password protected writable compact and digital versatile discs do not support secondary access if passwords are forgotten, the disc will become unusable, and should be disposed.

The password protected sub-window requires that one of it's options are chosen each time the disc is inserted into a computers disc drive before the disc can become operable, the sub-window will prompt the user of invalid entries and allow unlimited retries, a proper entry or action will cause the sub-window to disengage, and remove itself from the desktop window of the computers monitor, and allow access to the disc, and will only reappear upon each insertion of the disc into a computers disc drive that supports compact and digital versatile disc formats.

### DETAILED DESCRIPTION OF THE PREFERRED EMBODIMENTS (FIG. 4)

FIG. 4 illustrates a second preferred embodiment that isn't available with the present invention of writable compact and digital versatile discs that is similar to the first mentioned embodiment of FIG. 4, especially when the writable compact and digital versatile discs are to be used for music and/or video productions.

However, instead of using the password protected feature of the disc, it's possible to remove this feature from the disk permanently, which will allow the disc to be used for applications and devices not supported by passwords, such as the present invention of compact and digital versatile discs.

By the same procedure performed for example FIG. 4, components 3 and 3a, the password protected feature of the disc can be removed permanently with the selection of components 2, and 2a of the password protected option sub-window.

While the password protected option writable compact and digital versatile discs protect access to the information on the disc, it does not impede or disrupt the normal intended function of the disc, the discs perform just as compact and digital versatile discs are designed in the present invention of compact and digital versatile discs, with the exception of the on-board password protected option.

Finally, it is noted that the password protected option is a safeguard feature comprised within the present invention of writable compact and digital versatile discs, that expands the value and versatility of the discs, with it's unique access security feature that protects information stored on the discs. The password protected option further broaden it's relativity to the Information Technology industry by alleviating the technical process of having to encrypt files, to protect them before storing them on the present invention of writable compact and digital versatile discs.

This invention's scope shall be determined by the appended claims, and may be practiced otherwise than as specifically described. For example, a password may be assigned not only to protect information on the discs, but also to restrict use of the disc before any information is ever applied.

1. A process in which a password protected option is comprised within writable compact and digital versatile discs, said process comprising:
an option to assign a password to writable compact and digital versatile discs or an option to skip the process of assigning a password, said password protected option allows for passwords to be changed, removed, or allows for the password protected option feature to be removed from the writable compact and digital versatile disc permanently.

2. The process of claim 1, wherein said password protected options are displayed in a sub-window on the desktop window of a computers monitor after said password protected option writable disc has been placed into a computers disc drive and data on the disk is read, said password protected option allows for any combination of a four to seven character alphanumeric password to be entered, assigned new, changed, removed or skipped each time the disc is inserted into a computers disc drive that supports compact and digital versatile disc formats, one of said password protected options must be chosen before writable access or typical use of the disc is allowed, even if the disc becomes un-writable, said password protected option sub-window will disengage, and remove itself from the desktop window of the computers monitor upon completion of a chosen task, and will only reappear upon each insertion of the disc into a computers disc drive that supports compact and digital versatile disc formats.
